(19) United States
(12) Patent Application Publication
(10) Pub. No.: US 2023/0415050 A1
(43) Pub. Date: Dec. 28, 2023

(54) SYSTEMS AND METHODS FOR RIDE SYSTEM AUDIO AND VISUAL EFFECT SYNCHRONIZATION

(71) Applicant: Universal City Studios LLC, Universal City, CA (US)

(72) Inventors: Gregory Shellman Hall, Orlando, FL (US); Rachel Nicole Migliacci, Windermere, FL (US); Matthew Robert Rossett, Orlando, FL (US); Dante Lamar Bruno, Orlando, FL (US)

(21) Appl. No.: 17/887,069

(22) Filed: Aug. 12, 2022

Related U.S. Application Data
(60) Provisional application No. 63/354,559, filed on Jun. 22, 2022.

(51) Int. Cl. A63G 31/00; H04R 3/00; G06F 3/16

(52) U.S. Cl. CPC A63G 31/00; H04R 3/00; G06F 3/165; H04R 2499/13

(57) ABSTRACT

The present disclosure is directed to a ride effect coordination system that includes a ride vehicle and sensors that detect the ride vehicle positioning along the ride path. The sensors communicate the ride vehicle positioning data as position data to other controllers in the system. The ride effect coordination system includes an audio system to play audio for one or more riders of the vehicle, and an effect system configured to present a special effect that can be observed from the ride path. A controller may receive the position data and determine a timeframe for ride vehicle positioning so that the one or more riders can observe the special effect. The controller may also control the audio system to adjust play of the audio to coordinate a portion of audio with presentation of the special effect and the positioning of the ride vehicle based on the timeframe.

### CROSS REFERENCE TO RELATED APPLICATIONS

This application claims priority to and the benefit of U.S. Provisional Application No. 63/354,559, entitled “SYSTEMS AND METHODS FOR RIDE SYSTEM AUDIO AND VISUAL EFFECT SYNCHRONIZATION,” filed Jun. 22, 2022, which is hereby incorporated by reference in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

In entertainment venues such as theme parks, it has become more common to create ride systems with environments that include props, scenery, audiovisual and other media elements, and special effects that improve a guest's experience and that support a particular narrative of a respective environment. It is now recognized that providing properly timed audio and visual effects that are synchronized with ride activity of a ride system can provide improved immersive experiences for guests that are utilizing the ride system. However, synchronization of audio and visual effects with ride vehicle activity is challenging. Thus, it is now recognized that there is a need for improved systems and methods for facilitating coordination among the various components of a ride system to provide desired overall effects.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In accordance with an embodiment, a ride effect coordination system includes a ride vehicle that traverses a ride path and one or more sensors that perform operations to detect ride vehicle positioning along the ride path and communicate the ride vehicle positioning as positional data. Additionally, the ride effect coordination system includes an audio system configured to play audio for one or more riders of the ride vehicle and an effect system configured to present a special effect observable from the ride path. In addition, the ride effect coordination system includes a controller that performs operations to determine, based on the positional data, a timeframe for positioning the ride vehicle relative to the effect system such that the one or more riders can observe the special effect, and control the audio system to adjust play of the audio to coordinate a portion of the audio with presentation of the special effect and the positioning of the ride vehicle based on the timeframe.

In accordance with another embodiment, a method includes sensing, with one or more sensors, positioning of a ride vehicle along a ride path, communicating, with the one or more sensors, the positioning of the ride vehicle as positional data to a controller, and playing audio for one or more riders of the ride vehicle via an audio system. In addition, the method includes presenting, via an effect system, a special effect observable from the ride path, determining, based on the positional data, a timeframe for positioning the ride vehicle relative to the effect system such that the rider can observe the special effect, and controlling the audio system to adjust play of the audio to coordinate a portion of the audio with presentation of the special effect and the positioning of the ride vehicle based on the timeframe.

In accordance with another embodiment, a ride effect coordination system, includes a ride vehicle configured to traverse a ride path and one or more sensors configured to detect positioning of the ride vehicle along the ride path and communicate the positioning as positional data. Additionally, the ride effect coordination system includes an audio system configured to play audio for one or more riders of the ride vehicle, an effect system configured to present a special effect observable from the ride path, and a controller. The controller performs operations that include determining based on the positional data, a timeframe for positioning the ride vehicle relative to the effect system such that the one or more riders can observe the special effect, and controlling, based on the timeframe, the ride vehicle and the audio system to coordinate play of the audio and positioning of the ride vehicle such that a portion of the audio is presented in conjunction with presentation of the special effect while the ride vehicle is positioned relative to the effect system such that the one or more riders can observe the special effect.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a ride system in accordance with an embodiment of the present disclosure;

FIG. 2 is a schematic diagram of control hardware of the ride system of FIG. 1, in accordance with an embodiment of the present disclosure;

FIG. 3 is a flow diagram of a ride system synchronization process, in accordance with an embodiment of the present disclosure; and

FIG. 4 is a flow diagram of an audio system synchronization process, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

The present disclosure generally relates to systems and methods for synchronizing or coordinating effects with ride activity (e.g., ride vehicle positioning or ride vehicle motion). For example, an embodiment of the present disclosure relates to synchronizing certain audio effects (e.g., music, sound effects) and visual effects (e.g., an electronic video presentation, movements of an automated figure, pyrotechnics) based on ride vehicle positioning or movement within the ride system. In some embodiments, ride vehicle positioning may be adjusted to coordinate with effects (e.g., audio, visual, haptic) as well.

Users in an interactive environment or participating in an immersive experience may be located in a ride vehicle that changes position within a ride system (e.g., as the ride vehicle traverses a path of the ride system), and may be exposed to multiple audio and visual effects while traveling (e.g., moving along a ride track). For example, the ride system may employ an audio track that is played throughout the ride experience to create a mood, a narrative, a distraction, or the like for facilitating enjoyment of the ride by the users (e.g., riders). The ride vehicle's position may be communicated to a central ride controller as the ride vehicle moves within the ride system. Visual aspects of the ride may be directly associated with ride vehicle positioning because the position of the ride vehicle may essentially dictate what riders can observe in their immediate surroundings or at least what they are directly facing when properly positioned in the ride vehicle (e.g., seated and secured). This is the case for direct viewing but is also typically the case in rides that employ virtual and/or augmented reality devices, which typically display imagery based on location data for the device.

With respect to audio (such as the above-referenced audio track), the central ride controller may also receive audio data from one or more audio controllers that include or are associated with timestamps or other audio data of the audio track. The central ride controller may send control signals to the audio controller to control the audio (e.g., delay playing a certain portion of an audio track, or repeat certain portions) based on the ride vehicle position, so that the ride vehicle may be optimally positioned (within tolerances) to observe one or more audio and/or visual effects (e.g., dramatic audio and dramatic video effects) in unison (e.g., at the same time within associated tolerances). For example, effects may be coordinated with ride positioning so that users or riders can experience high volume or dramatic audio while viewing a special effect (e.g., a flame effect, an explosion, a confetti burst, intense lights) and an animated figure effect in combination. Indeed, certain points in the audio track (e.g., high energy portions, slow portions, portions with relevant lyrics) may be made to correspond with associated presentation of one or more effects and positioning of one or more ride vehicles for viewing such effects. In accordance with present embodiments, such coordination may be achieved by adjustments to the audio, other effects, or ride positioning.

As a specific example, special effects within the ride system may include a flame effect system. The flame effect system may include transmission portions (e.g., a tubing portion, a valve portion) embedded within a set piece (e.g., a dragon head prop, a rock band guitar, a musical instrument prop, a torch) and fluidly coupled to a combustible gas source (e.g., a tank of butane). One or more valves of the combustion system may coordinate with an ignition component (or multiple ignition components) to ignite and control gas flow to provide a flame effect. The one or more valves may be controlled, such as via a relay switch connected to a special effect controller that sends a signal to switch the relay switch on or off. The relay switch when switched on may actuate the one or more valves to open, causing a release of gas for generating a flame effect to be displayed. A signal to toggle the relay switch may be sent, in response to the special effect controller receiving one or more commands from the central ride controller.

The central ride controller may send one or more commands to the special effect controller, in response to the ride vehicle position reaching a trigger point for the special effect to be displayed. For example, the ride vehicle position data may be received by the central ride controller, and the central ride controller may send one or more special effect commands to the special effect controller to switch on the relay switch, which may actuate the one or more valves and enable release of combustible gas to display a flame effect based on the ride vehicle being positioned optimally or within a range that facilitates viewing the flame effect. The special effects system may also be synchronized to open designated valves and/or display particular flame effects based on certain audio (e.g., minor chords) playing within the audio track. This is one example of how present embodiments may coordinate particular aspects of music with effects and with proper positioning of the ride vehicle for observing the effects. In other embodiments, similar results are obtained with modified procedures. For example, the special effect controller and the central ride controller may be components of a single controller that manages multiple different components and avoids communications between separate controllers. As another example, different control mechanisms may be employed. For example, toggling the above-referenced relay to an off configuration (instead of an on configuration) to open a valve or actuate a valve via hydraulics that do not include a relay. Regardless of certain details, present embodiments utilize positional data of ride vehicles, effects, and audio to facilitate operational control for provision of an immersive audio and effect experience for guests in the ride vehicles.

The presently disclosed techniques permit a ride system to adjust one or more special effect systems and/or one or more audio tracks based on communication between the ride vehicle and one or more audio and visual effect systems. For example, if the ride vehicle position is delayed based on rider and/or mechanical issues, the audio system may be controlled to adjust music to accommodate delayed ride vehicle movement, so that the audio may go along with effects displayed to riders within the ride system. In other words, present embodiments can control audio (e.g., smoothly integrate and repeat a section of music, slow down the music, speed up the music) and visual effects during an interruption or process error (e.g., a ride delay) to maintain the integrity of a choreographed set of effects based on ride positioning to facilitate observation of the effects in conjunction with appropriate audio. In this way, the user or rider experience throughout the ride system is made more immersive and interesting. For example, a crescendo of a portion of music can be timed with an effect to create a desired mood (e.g., intensity level) even when the ride is running slightly off of a standard pace or when some other interruption has occurred. The ride system may also dynamically update one or more ride components based on ride vehicle position at any point throughout the ride.

Detecting that a ride vehicle is delayed or overly advanced may be based on comparison of location information with a coordination itinerary. The coordination itinerary may include instructions, information, or data indicating a set order of operations for effects, audio, and ride positioning. For example, the coordination itinerary may provide a timing of interactions of ride system features (e.g., activating an effect in coordination with a change in music and positioning of a ride vehicle for observing the effect). One or more sensors (e.g., a camera, weight sensor, pressure sensor, barcode reader) for detecting ride vehicle positioning may obtain information about positioning (e.g., location, orientation) of the ride vehicle and communicate the information to a controller (e.g., a central rider controller) as positional data. Using this data and known information about the ride system, the controller may determine a timeframe (e.g., a range of times, a timing designation) for positioning the ride vehicle relative to an effect that is observable along a ride path (e.g., a track, a rail, an open area, a bordered trail) for the ride vehicle. For example, a prediction can be made regarding future alignment of effects and positioning based on established operations and/or operational models. Likewise, timing of audio may be determined for this alignment of the ride vehicle with observability of the effect. This may be compared with a previously established itinerary to identify adjustments that must be made (e.g., based on changes, such as a delay in ride vehicle movement) to achieve the desired coordination of effects and ride positioning. Once adjustments are made (e.g., the audio is repeated, slowed, sped up), a new coordination itinerary can be established. If the ride is indefinitely delayed or stalled this may be accommodated (e.g., adjustments to audio may be made) and then a new coordination itinerary can be established once movement begins again. In some embodiments, adjustments to any of outboard effects, outboard audio, onboard audio, and vehicle movement may be made to align with the coordination itinerary before adjusting the coordination itinerary.

The central ride controller may collect data from one or more ride vehicles, audio systems, special effect systems, and the like. The central ride controller may analyze the data according to pre-set ride show effects that are pre-set to display when the ride vehicle is at a certain position in the ride system (e.g., in a position that facilitates viewing, feeling, or otherwise observing an effect). The central ride controller may also send commands to the audio controller to cut out certain portions of audio when ride vehicle progression along an intended path is delayed and/or loop (e.g., repeat a certain amount of times) certain portions of audio to ensure that the audio effect lines up with a visual effect at a certain position of the ride vehicle. It should be understood, that any ride element may be sent instructions dynamically based on the central ride controller collecting audio, ride position, and effect information throughout the ride system to enable synchronization of the ride vehicle with audio and visual effects.

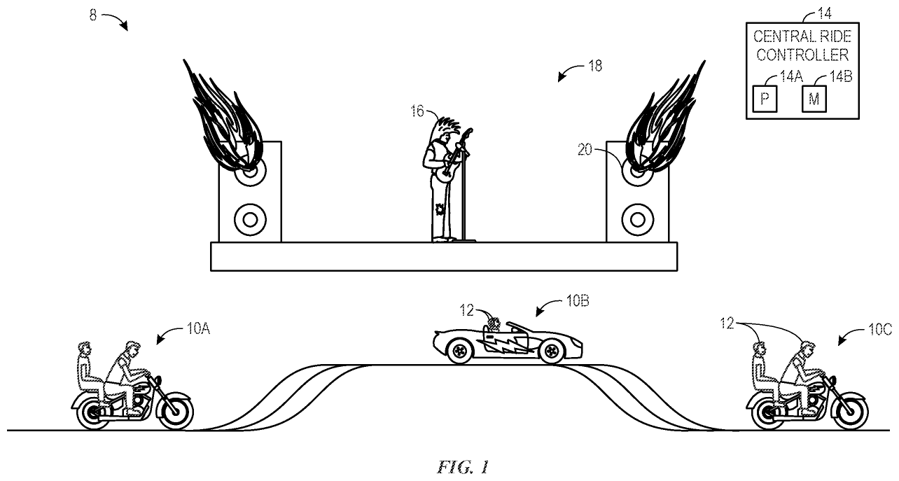

Certain aspects of the present disclosure may be better understood with reference to FIG. 1, which generally illustrates a ride system 8 in accordance with present embodiments. As illustrated, a plurality of users 12 (e.g., guests or riders) are guided via one of several ride vehicles (e.g., racecars, motorcycles) 10A, 10B, 10C throughout the ride system 8. The ride vehicles 10A, 10B, 10C may be guided via a track system and/or any other guidance system for ride vehicle movement throughout the ride system 8. For example, each of the ride vehicles 10A, 10B, 10C may be self-propelled and guided by an onboard or remote controller, which may enable each of the ride vehicle 10A, 10B, 10C to have some level of autonomy and may also emphasize a lack of uniformity in their relative positioning (e.g., spacing between the ride vehicles 10A, 10B, 10C). The ride vehicles 10A, 10B, 10C may move throughout one or more special effect areas 18 located throughout the ride system 8. The special effect areas 18 may include an animated FIG. 16 (e.g., an automated marionette), a flame effect or other pyrotechnics, an explosion, a confetti burst, intense lights, an audio effect, a haptic effect, a cooling or heating effect, or any other suitable effect for the ride system's immersive experience. The ride system 8 may also include a central ride controller 14 including one or more processors 14A and a memory 14B that may communicate with the ride vehicle 10 and one or more audio controllers and/or effect controllers of the ride system 8 via a network of the ride system 8. In some embodiments, each of these controllers are embodied in a single controller (e.g., the central rider controller 14) to facilitate improved communication between the various controllers, which may be considered virtual controllers.

Each of the ride vehicles 10A, 10B, 10C within the ride system 8 may communicate respective ride vehicle position data with the central ride controller 14, or may communicate with an audio controller, an effect controller, or any other element of the ride system 8. With respect to a predetermined or choreographed ride experience, the ride vehicle position (e.g., location along a path or orientation at a location) may be off course (e.g., delayed and/or ahead of pre-set or corresponding audio and visual effects), as may be determined based on the ride vehicle position data and a timeline (e.g., as defined by the coordination itinerary). In accordance with present embodiments, a controller, such as the central rider controller 14, operates to correct the ride experience by adjusting aspects of the ride experience to align with a timeframe and location or predicted location of the ride vehicle (e.g., ride vehicle 10A, 10B, or 10C) based on the respective ride vehicle position data.

For example, to mitigate a positional offset or a change in position for a particular ride vehicle relative to a set template (e.g., a change that impacts a timeframe of alignment relative to a coordination itinerary), the ride vehicle position data for the particular ride vehicle may be sent to a controller (e.g., the central rider controller 14, which may control various effects) and/or directly to one or more dedicated audio and/or effect systems, so that the audio and/or ride effects may be dynamically updated to sync to the updated ride vehicle positions. This may ensure specific audio and visual effects are displayed when each of the ride vehicles 10A, 10B, 10C is located at a desired position (e.g., range of locations that allow for effect observation) within the ride system 8 for viewing or otherwise observing the visual effects within the special effect area 18. For example, each ride vehicle 10A, 10B, 10C may include an individual audio system that plays specific portions of an audio track based on a current position of the ride vehicle 10A, 10B, 10C. More specifically, for example, the central ride controller 14 may determine that the audio track being played for riders of the first ride vehicle 10A via a speaker located within the ride vehicle 10A or an external speaker within the ride system 8 needs adjustment based on location information (e.g., current and/or predicted positioning) of the ride vehicle 10. The central ride controller 14 may send a command to the first ride vehicle's 10A audio system to skip to or speed up to reach a timestamp of the audio track that corresponds to a special effect being displayed at the special effect area 18 corresponding to the location information. Likewise, based on the position data, activation of a visual effect or other effect may be delayed or moved up to coordinate with desired vehicle positioning. In some embodiments, predicted location (e.g., a likely location at a future time based on sensor data and a predictive model) may be used to adjust for delays (e.g., activation delays or communication delays) so that such delays are accounted for when identifying a location that the ride vehicle 10A will be in when a particular effect is actually active.

In one example, the second ride vehicle 10B may be positioned at a specific point along a ride path (e.g., a track), and may be exposed to the special effect area 18 that includes the animated FIG. 16 and one or more valves 20 that may be programmed to emit a flame effect (or, for example, a confetti burst). In addition, the ride system 8 may operate to present audio (e.g., music, script) that is synched with operation of the ride system 8 so that a specific portion of audio is played when the ride vehicle 10 is positioned at the special effect area 18. The ride system 8 may include the central ride controller 14 that includes one or more timecodes that relate to certain audio and/or visual effects and positional data for a ride vehicle. The timecodes may be adjusted to accommodate positional offsets from an expected position for a particular vehicle at a particular time. These adjustments may be made based on sensor data indicative of a current or recent vehicle position. For example, when the second ride vehicle 10B is near or positioned at and/or exposed to the special effect area 18, a controller of the second ride vehicle 10B may send position data to the central ride controller 14 of the ride system 8 and the central ride controller 14 may use the position data to update or modify effect timing (e.g., audio effect, visual effects, haptic effects). In other embodiments, the ride effect system may include a sensor that senses the second ride vehicle 10B is within range of the effect system, and sends a signal to the central ride controller 14 to trigger one or more special effects. The central ride controller 14 of the ride system 8 may determine, based on the position data, that the special effect should be presented, and send a signal to the special effect area 18 that may send control signals to actuate, for example, the animated FIG. 16 and/or open the one or more valves 20 in response to the second ride vehicle 10B being positioned at the special effect area 18. The central ride controller 14 may also send a signal to an audio system that may synchronize background audio to the flame effect and/or the animated FIG. 16. In certain embodiments, the chords of the music played by the audio system, may be timed to the flame effects, so that flame effects are displayed and give the illusion to guests of the second ride vehicle that the music is timed to certain flame effects. This enables, the second ride vehicle position to synchronize with the ride effects and the audio system of the ride system 8. For example, an audio track may include a musical chorus, and an additional segment of the audio track may include a crescendo that may be timed to initiate based on when the second ride vehicle 10B is positioned at the special effect area 18 and exposed to one or more special effects. In this way, the audio may include additional audio components as part of the special effect experience, based on the ride vehicle's position.

In an embodiment, a ride vehicle's position may be delayed or ahead of a planned timeframe for desired audio being emitted by the audio system. The ride vehicle's position may be sent to the central ride controller 14 along with the audio timestamp that corresponds to the current audio being played. To adjust the ride system 8 based on the ride vehicle position data, the central ride controller 14 may send a signal to the special effect area 18 to control the one or more valves 20 to adjust the flame effect to the delayed timestamp of the audio. In other examples, the flame effect could be adjusted to be released earlier and/or later depending on the timestamp of the music received at the special effect area 18 and/or the central ride controller 14. In some embodiments, each ride vehicle 10A, 10B, 10C may correspond to an individual audio system. In this way, the audio within each of the ride vehicles 10A, 10B, 10C may be customized to individual ride vehicle movement. This enables each ride vehicle 10A, 10B, 10C to adjust audio differently than other ride vehicles 10A, 10B, 10C that may be positioned along a ride path (e.g., a track).

It should be understood that any suitable logic controls may be used to implement the ride system synchronization disclosed herein. With the foregoing in mind, FIG. 2 is a schematic diagram of the control hardware of the ride system 8, in accordance with embodiments of the current disclosure. The ride system 8 may include the central ride controller 14 (e.g., programmable logic controller (PLC)) that may communicate with one or more ride controllers 32 that may be located within each ride vehicle 10, one or more audio controllers 24, a special effect controller 26 connected to a relay switch 28, and an animated figure controller 30 via a network 22. The central ride controller 14 may receive ride position data and audio data over the network 22, and may send commands based on analyzing the ride position data and the audio data to the one or more ride controllers 32, the audio controller 24, the special effect controller 26, the animated figure controller 30, and any other suitable control element within the ride system 8. The network 22 may be any suitable computer network that enables different electronic devices (e.g., servers), communication components (e.g., routers), and the like to facilitate the communication between components of the ride system 8. Each controller may be connected to a network switch that enables network connection and communication between all the elements of the ride system 8.

In some embodiments, the ride system 8 may include one or more flame effects that are synched to audio that is playing throughout the ride system 8. The flame effects may also correspond to animated figure movement, and a position of the ride vehicle 10, such that guests 12 in the ride vehicle 10 may optimally observe the flame effect. To do this, the ride vehicle 10 may send position data to the central ride controller 14, which may analyze the position data according to pre-set position data for ride effects stored in a memory. The central ride controller 14 may send the received position data to the special effect controller 26 and the audio controller 24. The special effect controller 26 may determine that the ride vehicle 10 is positioned in the optimal position (e.g., a range of positions that facilitate observing an effect) for viewing the flame effect, and may send a signal to open and/or close a relay switch 28 that actuates the one or more valves 20 of the special effect area 18 that release combustible gas to create the flame effect. The audio controller 24 may also determine the ride vehicle 10 is an optimal distance for viewing the flame effect, and may play one or more audio sequences that correspond to the flame effect. In some embodiments, an animated figure controller 30 may receive special effect controller 26 data and may turn around, and/or change position and/or orientation relative to the guests of the ride vehicle 10. It should be understood, that each of the special effect controller 26, the ride controllers 32, and the audio controller 24 may attach to network switches that attach to other controllers on the network, so that communication between controllers is enabled for the ride system 8. In some embodiments, each controller may communicate with other controllers within the ride system 8 without sending data to the central ride controller 14.

In some embodiments, the audio playing throughout the ride vehicle's movement throughout the ride system 8 may be played continuously throughout the ride system 8, and portions of the music played during the one or more ride vehicles 10 viewing the special effect area 18 may be dramatic (e.g. louder music, brighter flame, bigger flame) when the ride vehicle 10 is optimally positioned to view the flame effect. For example, the audio track may be pre-loaded into a memory of the special effect controller 26, and the special effect controller 26 may actuate certain valves 20 corresponding to certain chords of the audio track. The audio track may also send one or more timestamp updates to a central ride controller 14, which may send the updated timestamp data to the special effect controller 26. It should be understood, that any ride element may be synched to another via the central ride controller 14 coordinating commands based on ride element information.

In other embodiments, the flame effect and the audio effect may be pre-synched to display at a certain time based on pre-stored ride vehicle position data within the central ride controller 14 that estimates the position of the ride vehicle 10 throughout the ride system 8. The audio effect may be adjusted if the ride vehicle position on the track is delayed or sped up relative to the pre-stored data. In the event the ride vehicle's position is off-track from the pre-stored data, the central ride controller 14 may detect the ride vehicle position is off track, and may send a signal to the audio controller 24 to delay, loop, or skip forward in the audio track to correspond to the ride vehicle 10 position. The audio controller 24 may send the current timestamp data within the audio track to the special effect controller 26, and the special effect controller 26 may synchronize the flame to the current timestamp data of the audio track playing throughout the ride system 8 and/or playing within a specific ride vehicle 10 of the ride system 8. It should be understood, that each ride vehicle 10 may include an audio system that plays a specific audio track that corresponds to a custom pattern of valve actuation based on the ride being positioned in the optimal position to view the flame effect. Additionally, the animated figure controller 30 may include pre-stored data to include certain movements that correspond to the audio track being played. The animated figure controller 30 may be sent timestamp data corresponding to the audio being played, so that the animated figure controller 30 may move according to the movements corresponding to the timestamp of the audio track. In other embodiments, the animated figure controller 30 may cause movement in a pre-set back and forth motion (e.g., guitar playing), and the flame effect and audio track may be synched to the pre-set motion of the animated FIG. 16.

In some embodiments, the ride system 8 may have an issue that stops and/or delays one or more ride vehicles 10. In this situation, the central ride controller 14 may detect, based on ride position data received from the vehicles, that the ride vehicles 10 have been paused or cumulatively delayed for a threshold amount of time, and the central ride controller 14 may send a signal to the audio controller 24 to switch over to playing an adjustment audio track (e.g., a B-roll, pre-stored track, default track) so that the audio track synched to the special effect is not delayed as result of the ride system 8 issue. The central ride controller 32 may then determine, based on the ride vehicle 10 position, that the ride vehicle 10 has resumed motion or caught up, and send a signal to the audio controller 24 to resume audio that corresponds to one or more special effects within the ride system 8. The adjustment audio track may be blended essentially seamlessly with the primary audio track and may even include a repeating portion of the primary audio track, which may avoid notice by guests or riders.

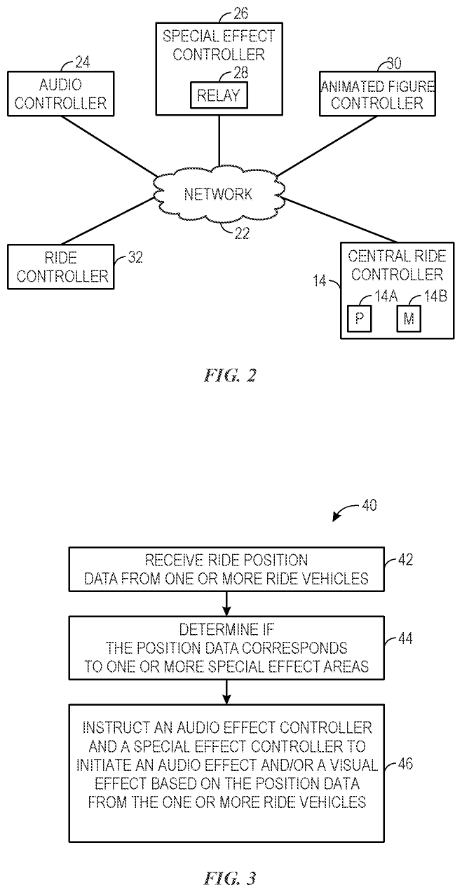

Keeping the foregoing in mind, FIG. 3 is a flow diagram of a method 40 for ride system 8 synchronization, in accordance with embodiments of the present disclosure. A central ride controller 14 may receive location data of the one or more ride vehicles 10 within the ride system 8, and may send control commands and/or location data to an audio controller 24 and a special effect controller 26 of the ride system 8 based on the ride location data. The central ride controller 14 may also include a memory that stores a timecode that includes a sequence of one or more special effects based on a position of the ride vehicle 10.

The central ride controller 14, at block 42, receives ride position data corresponding to current ride position data of one or more ride vehicles 10 within the ride system 8. The current ride position data may include identification information for the ride vehicle 10 corresponding to the ride position data, so that differing effects may be presented for each of the ride vehicles 10 within the ride system 8.

The central ride controller 14 determines, at block 44, if the position data for the one or more ride vehicles corresponds to one or more special effect areas 18. The one or more special effect areas 18 may be one or more positions (e.g., ranges of specific locations) in the ride system 8 that correspond to optimal viewing of one or more special effects (e.g., light effect, auditory effect, flame effect, animated figure effect). There may be multiple special effect areas 18 that each display different effects throughout the ride system 8. Additionally, each ride effect system may be sent a command to present (e.g., display or activate) a personalized effect for each ride vehicle 10 within the system.

The central ride controller 14, at block 46, instructs an audio effect controller and a special effect controller 26 to initiate or synchronize an audio effect and/or a visual effect based on the position data for the one or more ride vehicles 10 corresponding to the special effect areas 18. For example, the first ride vehicle 10A may be associated with position data indicating that the first ride vehicle 10A is in a first special effect area 18 or immediately approaching the first special effect area 18. This may be based on comparing the ride vehicle position data and ride effect position data stored in a memory of the central ride controller 14. The central ride controller 14 may send a signal to the audio controller 24 and the special effect controller 26 to provide a visual and audio effect at the first ride effect point. The audio effect may be manipulated in various ways (including in advance of reaching the special effect area 18) to seamlessly synchronize music with timing for other planned effects (e.g., a flame effect). As noted above, this may include speeding up the music, slowing down the music, adding repetition in the music, or removing segments of the music to adjust timing to correspond to the relevant effect (e.g., the flame effect).

Additionally, the ride system 8 controller may determine that a second ride vehicle is positioned within or near a second ride effect point (e.g., the special effect area 18) based on the ride vehicle 10 position data. The central ride controller 14 may send a signal to an additional audio effect controller and an additional special effect controller to display a different visual and audio effect for the second ride vehicle 10. It should be understood, that any suitable number of special effect areas 18 may be present within the ride system 8 and stored within a memory of the central ride controller 14. It should also be understood that in some embodiments, each of the ride vehicle 10 controllers may send position data directly to one or more audio effect controllers and special effect controller 26 within the ride system 8, and the audio effect controllers and the special effect controllers 26 may send signals to display certain visuals or play certain audio tracks based on the ride vehicle 10 position data.

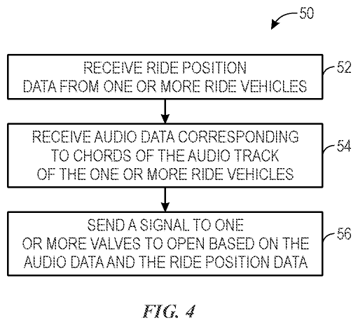

With the foregoing in mind, FIG. 4 is a flow diagram of a method 50 for audio system synchronization, in accordance with embodiments of the current disclosure. A central ride controller 14 may receive ride position data from one or more ride systems 8, and may receive audio data corresponding to segments (e.g., particular chords or lyrics) of one or more audio tracks. The central ride controller 14 may determine a ride position and an audio track timestamp, and may send a signal to one or more valves of a special effect system to open to create a flame effect based on the ride vehicle position and the audio track timestamp.

The central ride controller 14, at block 52, receives ride position data from one or more ride vehicles 10 that are located within the ride system 8. The ride position data may indicate that one or more ride vehicles 10 have passed a trigger point and/or sensor that determines that the ride vehicle 10 is positioned within optimal viewing range of the special effect area 18. The central ride controller 14, at block 54, receives audio data corresponding to one or more musical cords of an audio track of the one or more ride vehicles 10. The audio data may include a timestamp associated with the audio track currently playing in the one or more ride vehicles 10 within the ride system. The central ride controller 14 may determine, based on the ride vehicle position, if the ride vehicle 10 is positioned at the special effect area 18. The central ride controller 14 may then determine one or more segments of the audio track that are intended to correlate to the special effect area 18 and manipulate play of the audio track and/or operation of the special effect area 18 to synchronize with positioning of the ride vehicle 10 to create an immersive and coordinated effect experience. In the embodiment illustrated by FIG. 4, the special effect area 18 (e.g., a flame effect controlled via a valve) is adjusted to coordinate with the audio and location data.

The central ride controller 14, at block 56, sends a signal to one or more special effect controllers to open one or more valves that correspond to a flame effect in response to receiving the ride vehicle position and audio data. The one or more valves may correspond to the chords of the audio track that is currently playing to the ride vehicle 10 within the ride system 8 based on the timestamp data, and the audio segment (e.g., chord or lyrics data) stored in a memory of the central ride controller 14. The special effect system may then display one or more flames corresponding to the musical track and in view of the one or more ride vehicles 10. It should be understood that any suitable number of valves may be used to display the flame effect within the ride system 8.

While only certain features of the present disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function]. . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. A ride effect coordination system, comprising:
a ride vehicle configured to traverse a ride path;
one or more sensors configured to detect ride vehicle positioning along the ride path and communicate the ride vehicle positioning as positional data;
an audio system configured to play audio for one or more riders of the ride vehicle;
an effect system configured to present a special effect observable from the ride path; and
a controller configured to:
determine, based on the positional data, a timeframe for positioning the ride vehicle relative to the effect system such that the one or more riders can observe the special effect; and
control the audio system to adjust play of the audio to coordinate a portion of the audio with presentation of the special effect and the positioning of the ride vehicle based on the timeframe.

2. The ride effect coordination system of claim 1, wherein the controller is configured to control the audio system to slow down play of the audio based on the timeframe indicating that the ride vehicle is delayed relative to a previously established coordination itinerary.

3. The ride effect coordination system of claim 1, wherein the controller is configured to control the audio system to repeat a segment of the audio based on the timeframe indicating that the ride vehicle is delayed relative to a previously established coordination itinerary.

4. The ride effect coordination system of claim 3, wherein the controller is configured to control the audio system to repeat the segment of the audio a number of times based on an extent to which the ride vehicle is delayed relative to the previously established coordination itinerary and such that an additional segment of the audio is played with the ride vehicle positioned relative to the effect system to allow the one or more riders to observe the special effect.

5. The ride effect coordination system of claim 4, wherein the segment of the audio comprises a musical chorus and the additional segment of the audio comprises a crescendo.

6. The ride effect coordination system of claim 1, wherein the effect system comprises a pyrotechnic effect, an animated figure effect, a cooling effect, a heating effect, a haptic effect, or a combination thereof.

7. The ride effect coordination system of claim 1, wherein the controller is configured to control the audio system to speed up at least a portion of the audio based on the timeframe indicating that the ride vehicle is ahead of a previously established coordination itinerary.

8. The ride effect coordination system of claim 1, wherein the controller is configured to delay activation or actuation of the effect system based on the timeframe indicating that the ride vehicle is delayed relative to a previously established coordination itinerary.

9. The ride effect coordination system of claim 1, wherein the controller comprises an audio system controller configured to control the audio system, an effect system controller configured to control the effect system, and a ride vehicle controller configured to control the ride vehicle.

10. The ride effect coordination system of claim 1, wherein the controller comprises a central controller configured to control the effect system and the audio system based on control instructions provided to one or more additional controllers.

11. The ride effect coordination system of claim 1, comprising a plurality of ride vehicles configured to move along the ride path and configured to be coordinated within the ride effect coordination system by the controller.

12. A method of coordinating ride effects, the method comprising:
sensing, with one or more sensors, positioning of a ride vehicle along a ride path;
communicating, with the one or more sensors, the positioning of the ride vehicle as positional data to a controller;
playing audio for one or more riders of the ride vehicle via an audio system;
presenting, via an effect system, a special effect observable from the ride path;
determining, based on the positional data, a timeframe for positioning the ride vehicle relative to the effect system such that the one or more riders can observe the special effect; and
controlling the audio system to adjust play of the audio to coordinate a portion of the audio with presentation of the special effect and the positioning of the ride vehicle based on the timeframe.

13. The method of claim 12, comprising controlling the audio system to adjust the play of the audio by slowing a speed of the audio based on the timeframe indicating that the ride vehicle is delayed relative to a previously established coordination itinerary.

14. The method of claim 12, comprising controlling the audio system to repeat a segment of the audio based on the timeframe indicating that the ride vehicle is delayed relative to a previously established coordination itinerary.

15. The method of claim 12, comprising directing movement of the ride vehicle via the controller.

16. A ride effect coordination system, comprising:
a ride vehicle configured to traverse a ride path;
one or more sensors configured to detect positioning of the ride vehicle along the ride path and communicate the positioning as positional data;
an audio system configured to play audio for one or more riders of the ride vehicle;
an effect system configured to present a special effect observable from the ride path; and
a controller configured to:
determine, based on the positional data, a timeframe for positioning the ride vehicle relative to the effect system such that the one or more riders can observe the special effect; and
control, based on the timeframe, the ride vehicle and the audio system to coordinate play of the audio and positioning of the ride vehicle such that a portion of the audio is presented in conjunction with presentation of the special effect while the ride vehicle is positioned relative to the effect system such that the one or more riders can observe the special effect.

17. The ride effect coordination system of claim 16, wherein the controller is configured to control a speed of the ride vehicle, control the audio system to manage a speed of play of the audio, or both based on the timeframe indicating that the ride vehicle and the audio are out of sync relative to a coordination itinerary.

18. The ride effect coordination system of claim 16, wherein the controller is configured to control a movement of the ride vehicle, control the audio system to manage play of the audio, or both based on the timeframe indicating that the ride vehicle and the audio are out of sync relative to a coordination itinerary.

19. The ride effect coordination system of claim 18, wherein the controller is configured to control the audio system to repeat a segment of the audio a number of times based a degree to which the ride vehicle and the audio are out of sync relative to the coordination itinerary.

20. The ride effect coordination system of claim 19, wherein the controller is configured to delay or expedite activation or actuation of the effect system based on the positional data.
